(19) United States
(12) Patent Application Publication
(10) Pub. No.: US 2003/0218775 A1
(43) Pub. Date: Nov. 27, 2003

(54) Print control method and printing apparatus

(75) Inventors: Hiroshi Udo, Ibaraki (JP); Seiji Kageyama, Ibaraki (JP); Shinichi Kishi, Ibaraki (JP); Muneyoshi Akai, Ibaraki (JP)

Correspondence Address: McGinn & Gibb, PLLC, Suite 200, 8321 Old Courthouse Road, Vienna, VA, 22182-3817, US

(73) Assignee: Hitachi Printing Solutions, Ltd., Ebina-City (JP)

(21) Appl. No.: 10/443,008

(22) Filed: May 22, 2003

(30) Foreign Application Priority Data
May 24, 2002 (JP) P.2002-150775

(51) Int. Cl. G06K 15/02; H04N 1/387

(52) U.S. Cl. 358/1.18; 358/450

(57) ABSTRACT

A printing apparatus includes a print data correcting section for correcting print data and a selecting section for selecting a correction-method to be used in the print data correcting section. The selecting section is formed so that the correction method is selected according to a posttreatment way of a posttreatment apparatus for performing posttreatment on a print result of the printing apparatus.

### BACKGROUND OF THE INVENTION

1. Field of the Invention

The present invention relates to a print control method for controlling a printing apparatus and to a printing apparatus.

2. Background Art

A printing apparatus which performs printing on print paper such as continuous-form paper by using an electronic photography process receives print data, converts the data to printable data in a data converter of a controller, and sends the resulting print data to a printing section. The printing section generates a latent image byway of an imaging mechanism, transfers toner onto the print paper. A fixing mechanism heats and fuses the toner and fixes the toner onto paper. The paper as a final print result is then dropped into a paper folding mechanism.

### SUMMARY OF THE INVENTION

The related art printing apparatus prints out print data sent from a higher-rank apparatus without changing the page layout. Thus, a multiple-copy printing process may perform printing which does not conform to the page layout requested by a posttreatment apparatus. This results in considerable workload of sorting printed paper. While multiple-page printing where more than one logical page is assigned in a single physical page is performed on wide continuous-form paper, it is difficult to change the page layout depending on whether to output the print data on a per copy basis or page basis.

Thus, an object of the invention is to provide a print control method which allows the page layout of print data to be changed thereby facilitating the posttreatment on the posttreatment apparatus.

In order to attain the problem, the invention provides a print control method for controlling a printing apparatus, including: registering page layout, the page layout corresponding to a posttreatment way of a posttreatment apparatus for performing posttreatment on a print result of the printing apparatus; and setting page layout of print data to be processed in the printing apparatus according to the registered page layout.

The invention also provides a printing apparatus, including: a print data correcting section for correcting print data; and a selecting section for selecting a correction method to be used in the print data correcting section. The selecting section is formed so that the correction method is selected according to a posttreatment way of a posttreatment apparatus for performing posttreatment on a print result of the printing apparatus.

Preferably, the correction method includes setting page layout of the print data. The posttreatment way includes a plurality of posttreatment ways. The selecting section is formed so that the page layout is selected from plural types of page layout each corresponding to the plurality of posttreatment ways.

Preferably, the printing apparatus further includes a correction data register section for registering the plural types of page layout. The selection section selects the page layout among from the registered plural types of page layout.

Preferably, the selection section includes an operation panel.

The aforementioned problem occurs because the print data sent from higher-rank apparatus does not agree with the page layout requested by posttreatment apparatus. Thus, the invention provides the correction data register section for previously registering page layout form which agrees with the form of posttreatment apparatus in a controller so as to allow selection of a page layout form required in printing on an operation panel. The invention also provides the data correcting section in a controller so as to allow page layout in accordance with the page layout form selected on the operation panel.

### BRIEF DESCRIPTION OF THE DRAWINGS

The present invention may be more readily described with reference to the accompanying drawings: in which

FIG. 1 is a general block diagram showing an embodiment of the invention;

FIG. 2 explains the principle of this invention (single-sided printing, three copies, two pages per sheet); and

FIG. 3 explains the principle of this invention (double-sided printing, three copies, two pages per sheet).

### DETAILED DESCRIPTION OF THE PREFERRED EMBODIMENTS

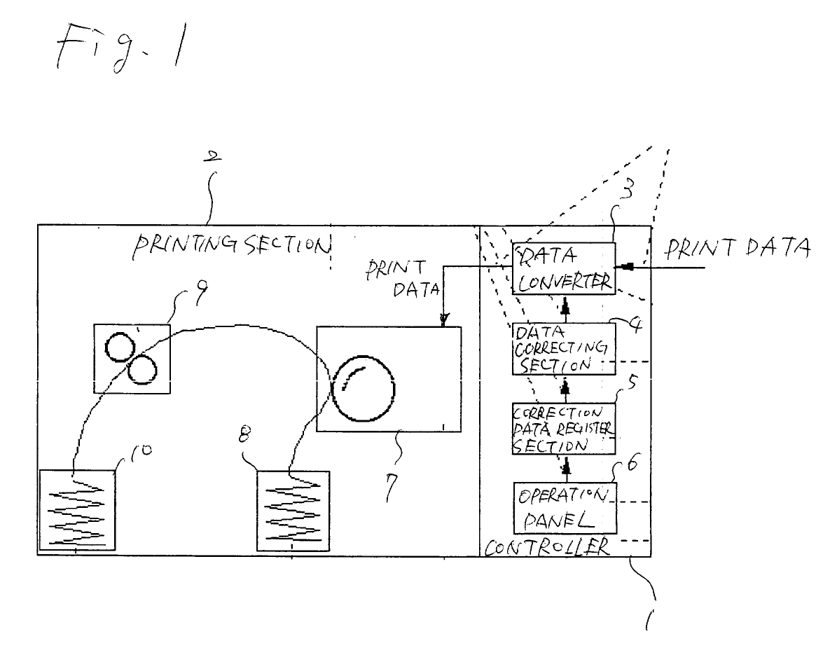

An embodiment of the invention will be described referring to the drawings. FIG. 1 is a general block diagram showing a multiple-copy print control method for electronic photography continuous-form paper printing apparatus according to an embodiment of the invention. In FIG. 1, a numeral 1 indicates a controller, 2 a printing section, 3 a data converter for converting received print data to data printable on the electronic photography continuous-form paper printing apparatus and sending the resulting data, 4 a data correcting section for correcting print data, 5 a correction data register section for registering correction data, 6 an operation panel for selecting or renaming correction data, 7 an imaging mechanism for generating a latent image and transferring toner onto print paper in accordance with the print data sent, 8 a paper feed mechanism, 9 a fixing mechanism, and 10 a paper folding mechanism.

The final print result undergoes posttreatment by a posttreatment apparatus (not shown). The posttreatment apparatus may be connected to the printing apparatus instead of the paper folding mechanism 10 for continuous processing of the print result.

The controller 1 changes page layout in the data correcting section 4 in accordance with a page layout form previously registered to the correction data register section 5 and selected on the operation panel 6 before sending print data to the printing section 2, thus printing the data on a new page layout.

The controller 1 analyzes the received print data by using a microcomputer to detect whether the print data proceeded by the electronic photography continuous-form paper printing apparatus is multiple-copy print data in order to determine the timing to change the page layout.

The page layout form is previously registered to the correction data register section 5 of the printing apparatus in accordance with the form of the posttreatment apparatus. In order to support a variety of page layout forms, a plurality of page layout forms can be registered to the printing apparatus.

The name of a registered page layout form can be changed as required on the operation panel 6. This allows a page layout form to coincide with its name thus enhancing operativity. A method for registering a page layout form on a higher-rank computer controlling the printing apparatus (not shown) provides the same effect.

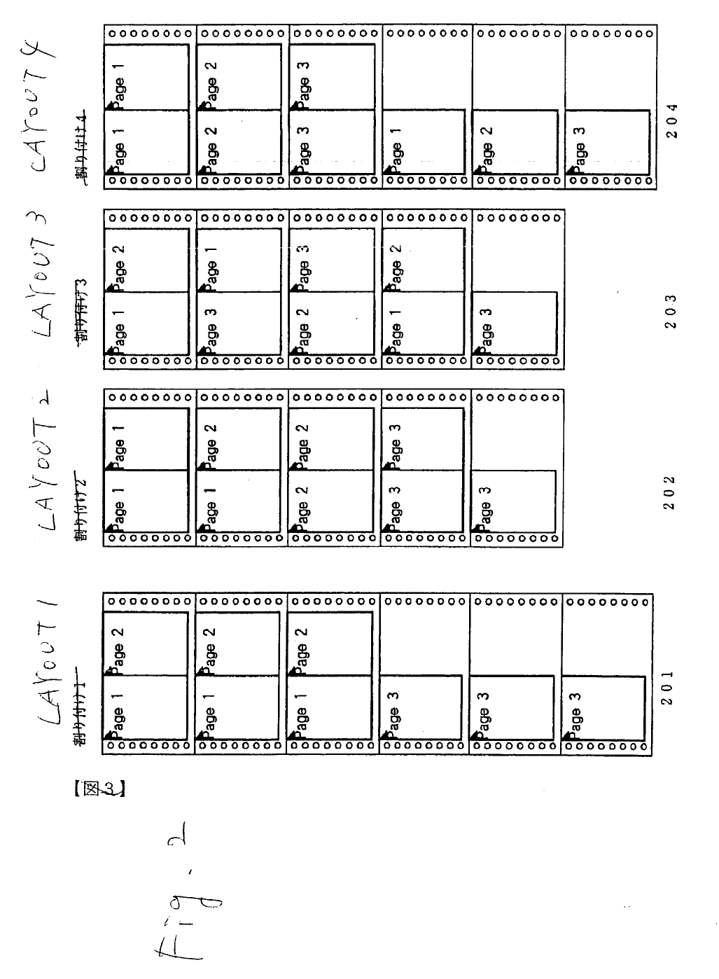

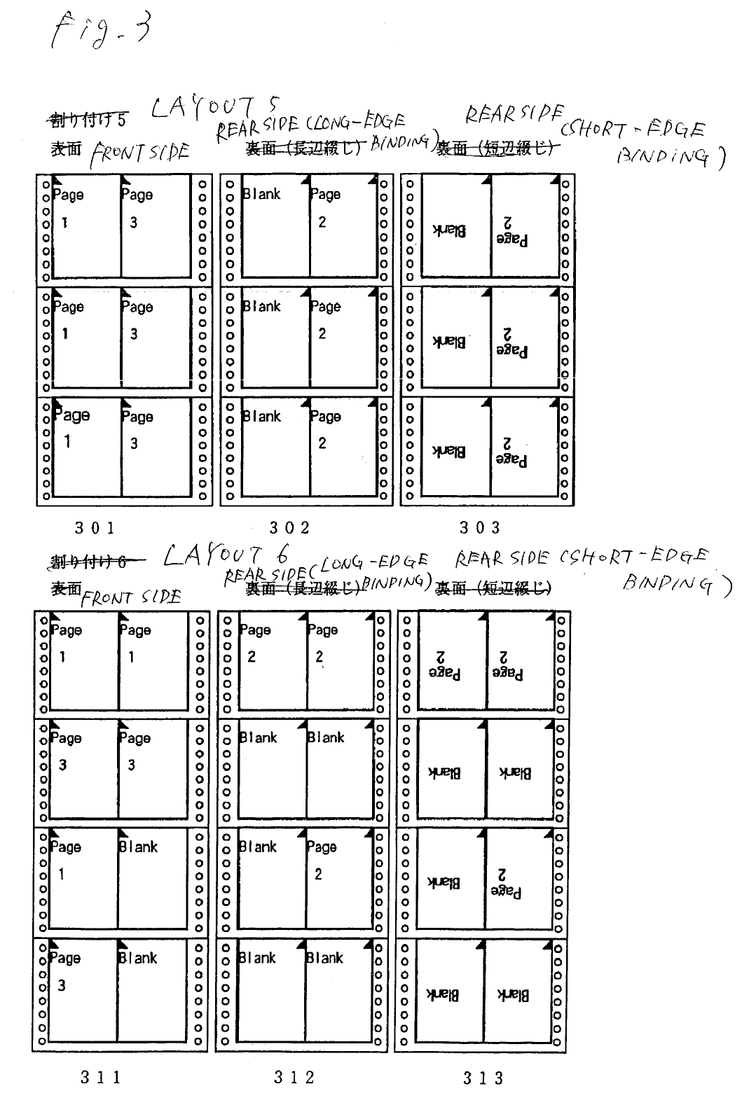

Next, the invention will be described referring to FIGS. 2 and 3. FIG. 2 shows a page layout method assuming three copies, two pages imposed on a sheet and single-sided printing in a multiple-copy control method according to an embodiment of the invention. Layout 1 is advantageous for obtaining a print result per page after cutting a sheet into pages of a desired size. Layout 2 is advantageous for obtaining a print result per page with pages stacked one on the other after cutting a sheet into pages of a desired size. Layout 3 is advantageous for obtaining a print result per copy with pages stacked one on the other after cutting a sheet into pages of a desired size. Layout 4 is advantageous for obtaining a print result per copy after cutting a sheet into pages of a desired size.

FIG. 3 shows a page layout method assuming three copies, two pages imposed on a sheet and double-sided printing in a multiple-copy control method according to an embodiment of the invention. Layout 5 is advantageous for obtaining a print result per copy with pages stacked one on the other after cutting a sheet into pages of a desired size. A numeral 302 shows the page layout of the rear side for long-edge binding. A numeral 303 shows the page layout of the rear side for short-edge binding. In any case, the page layout of the front side is combined with a numeral 301.

Layout 6 is advantageous for obtaining a print result per page after cutting a sheet into pages of a desired size. A numeral 312 shows the page layout of the rear side for long-edge binding. A numeral 313 shows the page layout of the rear side for short-edge binding. In any case, the page layout of the front side is combined with a numeral 311.

According to the invention, it is possible to provide a print control method which allows the page layout of print data to be changed thereby facilitating the posttreatment on a posttreatment apparatus.

What is claimed is:

1. A print control method for controlling a printing apparatus, comprising:
registering page layout, the page layout corresponding to a posttreatment way of a posttreatment apparatus for performing posttreatment on a print result of the printing apparatus; and
setting page layout of print data to be processed in the printing apparatus according to the registered page layout.

2. The printing control method as claimed in claim 1, wherein the registered page layout includes plural types of page layouts, each corresponding to a plurality of posttreatment ways of the posttreatment apparatus; and
the method further comprises selecting the page layout of print data from the plural types of page layout.

3. The printing control method as claimed in claim 2, wherein the selecting step includes selecting the page layout of print data on the basis of an operation on an operation panel.

4. A printing apparatus, comprising:
a print data correcting section for correcting print data; and
a selecting section for selecting a correction method to be used in the print data correcting section; wherein
the selecting section is formed so that the correction method is selected according to a posttreatment way of a posttreatment apparatus for performing posttreatment on a print result of the printing-apparatus.

5. The printing apparatus as claimed in claim 4, wherein
the correction method includes setting page layout of the print data;
the posttreatment way includes a plurality of posttreatment ways; and
the selecting section is formed so that the page layout is selected from plural types of page layout each corresponding to the plurality of posttreatment ways.

6. The printing apparatus as claimed in claim 5, further comprising:
a correction data register section for registering the plural types of page layout; wherein
the selection section selects the page layout among from the registered plural types of page layout.

7. The printing apparatus as claimed in claim 5, wherein the selection section includes an operation panel.
